(19) United States
(12) Patent Application Publication
(10) Pub. No.: US 2025/0136520 A1
(43) Pub. Date: May 1, 2025

(54) CEMENT, CEMENT COMPOSITION, CURED CEMENT PRODUCT, AND METHOD FOR PRODUCING CURED CEMENT PRODUCT

(71) Applicant: DENKA COMPANY LIMITED, Chuo-ku, Tokyo (JP)

(72) Inventor: Taiichiro MORI, Tokyo (JP)

(73) Assignee: DENKA COMPANY LIMITED, Chuo-ku, Tokyo (JP)

(21) Appl. No.: 18/835,639

(22) PCT Filed: Jan. 30, 2023
(86) PCT No.: PCT/JP2023/002891

§ 371 Date: Aug. 2, 2024

(30) Foreign Application Priority Data
Feb. 10, 2022 (JP) 2022-019299

(51) Int. Cl. C04B 40/02; C04B 111/00; C04B 111/10

(52) U.S. Cl. CPC C04B 40/0259; C04B 2111/00215; C04B 2111/10

(57) ABSTRACT

The cement of the present invention is cured by a carbonation reaction, the cement containing a γ-crystalline phase composed of γ-2CaO·SiO₂ (γ-C₂S), a β-crystalline phase composed of β-2CaO·SiO₂ (β-C₂S), and 2CaO·Al₂O₃·SiO₂ (C₂AS).

### TECHNICAL FIELD

The present invention relates to a cement, a cement composition, a cured cement product, and a method for producing a cured cement product.

### BACKGROUND ART

Various developments have been made on cement so far. As this kind of technique, for example, a technique disclosed in Patent Document 1 has been known. Patent Document 1 discloses a technology of kneading γ-2CaO·SiO₂, a water-dispersible polymer, and water to provide a cement cured body having high bending strength (Claim 1). In Patent Document 1, it is disclosed that, from the viewpoint of the feature of γ-2CaO·SiO₂ which behaves as a particle in an underwater environment, by using the water-dispersible polymer in combination, lubricating or dispersing action and plasticity are imparted to the γ-2CaO·SiO₂ particles (paragraph 0008), and the characteristic of high bending strength can be realized (paragraph 0005).

### RELATED DOCUMENT

### Patent Document

[Patent Document 1] Japanese Unexamined Patent Publication No. H04-214059

### SUMMARY OF THE INVENTION

### Technical Problem

However, as a result of the studies by the present inventor, it has been found that the γ-2CaO·SiO₂ particles disclosed in Patent Document 1 have room for improvement in workability, compression strength, storage stability, and temperature dependence.

### Solution to Problem

As a result of further studies, the present inventor has found that, by using a cement containing a γ-crystalline phase composed of γ-2CaO·SiO₂, a β-crystalline phase composed of β-2CaO·SiO₂, and 2CaO·Al₂O₃·SiO₂, workability, compression strength, storage stability, and temperature dependence in the cement can be improved in a well-balanced manner, and has completed the present invention.

According to one aspect of the present invention, the following cement, cement composition, cured cement product, and method for producing a cured cement product are provided.
1. A cement which is cured by a carbonation reaction, the cement containing:
a γ-crystalline phase composed of γ-2CaO·SiO₂ (γ-C₂S);
a β-crystalline phase composed of β-2CaO·SiO₂ (β-C₂S); and
2CaO·AlO₃·SiO₂ (C₂AS).
2. The cement according to 1.,
in which a content of the γ-C₂S is equal to or more than 30% by mass and equal to or less than 98% by mass in 100% by mass of the cement.
3. The cement according to 1, or 2.,
in which a content of the C₂AS is equal to or more than 0.5% by mass and equal to or less than 50% by mass with respect to 100% by mass of the γ-C₂S.
4. The cement according to any one of 1. to 3.,
in which the cement contains a heterophase existing in the γ-crystalline phase, and the C₂AS is contained in the heterophase.
5. The cement according to 4.,
in which Al₂O₃ is not contained in the γ-crystalline phase.
6. The cement according to any one of 1. to 5.,
in which Al₂O₃ is contained in the β-crystalline phase.
7. The cement according to any one of 1. to 6.,
in which a content of the β-C₂S is equal to or more than 1.0% by mass and equal to or less than 50% by mass with respect to 100% by mass of the γ-C₂S.
8. The cement according to any one of 1. to 7.,
in which the cement is in a powder form.
9. A cement composition containing:
the cement according to any one of 1. to 8.,
in which the cement composition is any one of a cement paste, a cement mortar, or a cement concrete.
10. The cement composition according to 9.,
in which the cement composition does not contain a Portland cement.
11. A cured cement product which is a cured product of the cement composition according to 9, or 10.
12. A method for producing a cured cement product, including:
a curing step of curing the cement composition according to 9, or 10. in an environment condition of a temperature of equal to or higher than 10° C. and equal to or lower than 150° C., a relative humidity of equal to or more than 10% and equal to or less than 80%, a CO₂ concentration of equal to or more than 0.1% and equal to or less than 90%, and a water vapor pressure of equal to or more than 3.0 hPa and equal to or less than 300 hPa.
13. The method for producing a cured cement product according to 12.,
in which a curing time in the curing step is equal to or more than 1 hour and equal to or less than 90 hours.
14. The method for producing a cured cement product according to 12. or 13.,
in which, in the curing step, a pressure-molded product is obtained by subjecting the cement composition according to 9, or 10. to a pressure-molding, or by subjecting a water slurry containing the cement composition according to 9, or 10. to a pressure-molding, and the pressure-molded product is cured in the environment condition.

### Advantageous Effects of Invention

According to the present invention, there are provided a cement having excellent workability, compression strength, storage stability, and temperature dependence; a cement composition containing the cement; a cured cement product; and a method for producing a cured cement product.

### BRIEF DESCRIPTION OF THE DRAWINGS

FIG. 1 is an SEM image of a cement A.

FIG. 2 is an SEM image of a cement B.

### DESCRIPTION OF EMBODIMENTS

An outline of the cement according to the present embodiment will be described.

The cement according to the present embodiment is a cement cured by a carbonation reaction, the cement containing a γ-crystalline phase composed of γ-2CaO·SiO₂ (hereinafter, also abbreviated as γ-C₂S), a β-crystalline phase composed of β-2CaO·SiO₂ (hereinafter, also abbreviated as β·C₂S), and 2CaO·Al₂O₃·SiO₂ (hereinafter, also abbreviated as C₂AS).

According to the findings of the present inventor, by using the cement containing the γ-C₂S, the β-C₂S, and the C₂AS, while improving workability and compression strength, reduction in workability or compression strength can be suppressed even in a case where the cement is stored under specified conditions, and reduction in workability or compression strength can be suppressed even under fluctuating temperature environments, preferably in a low-temperature environment, that is, storage stability and temperature dependence with regard to cement properties such as workability and compression strength can be improved.

According to the present embodiment, it is possible to obtain a cement having excellent workability, compression strength, storage stability, and temperature dependence.

In addition, by appropriately controlling a CaO/SiO₂ molar ratio according to a content of Al₂O₃ contained in a raw material, it is possible to obtain a cement entirely powdered.

Hereinafter, the cement according to the present embodiment will be described in detail.

The cement includes at least an inorganic baked product containing at least the γ-C₂S, the β-C₂S, and the C₂AS. The inorganic baked product means a molded product or a powder product having a predetermined shape, which is obtained by heating and baking an inorganic raw material.

Crystal types of the γ-C₂S, such as an α-type, a β-type, and a γ-type, have been known. These have different crystal structures and densities from each other. Among these, γ-C₂S which is a γ-type exhibits an effect of inhibiting neutralization. By performing forced carbonation with the γ-C₂S, densification in the cured cement product can be increased.

The γ-C₂S constitutes the γ-crystalline phase of the cement. The γ-crystalline phase may be contained in the cement as an inorganic matrix.

A lower limit of a content of the γ-C₂S is, for example, equal to or more than 30 parts by mass, preferably equal to or more than 35 parts by mass and more preferably equal to or more than 40 parts by mass in 100 parts by mass of the cement.

On the other hand, an upper limit of the content of the γ-C₂S is, for example, equal to or less than 98 parts by mass, preferably equal to or less than 95 parts by mass and more preferably equal to or less than 93 parts by mass in 100 parts by mass of the cement.

By setting the content in such a range, the workability and compression strength can be improved.

The cement may contain a heterophase existing in the γ-crystalline phase.

In at least one of SEM images of a fracture surface of the cement, the heterophase is present in the interior of a crystal grain of a crystal substance constituting the γ-crystalline phase consisting of the γ-C₂S or present along an interface of the crystal grain.

In the SEM images, the heterophase may be included in one or two or more in the crystal grain.

As a component constituting the heterophase, it is preferable that the cement contains the C₂AS. As a result, a carbonation rate can be further improved.

In the heterophase, a component other than the C₂AS may be present unavoidably.

A lower limit of a content of the C₂AS is, for example, equal to or more than 0.5% by mass, preferably equal to or more than 1.0% by mass and more preferably equal to or more than 2.0% by mass with respect to 100% by mass of the γ-C₂S. As a result, the workability, compression strength, storage stability, and temperature dependence can be improved.

On the other hand, an upper limit of the content of the C₂AS is, for example, equal to or less than 50, by mass, preferably equal to or less than 40% by mass and more preferably equal to or less than 30% by mass with respect to 100% by mass of the γ-C₂S. As a result, a balance of various characteristics can be achieved.

In the present embodiment, for example, by appropriately selecting the type and blending amount of each component contained in the cement, the method of preparing the cement, and the like, it is possible to control the presence of the above-described heterophase or the content of the component constituting the heterophase. Among these, examples of an element for obtaining the desired state of the presence of the above-described heterophase and the content of the component constituting the heterophase include using a raw material mixture containing a CaO raw material, an SiO₂ raw material, and an Al₂O₃ raw material, using a rotary kiln lined with a high-purity alumina brick and/or applying an alumina mortar having a predetermined concentration onto a brick surface inside the kiln, and appropriately adjusting the baking temperature, the dry pulverization, and the granule size.

A content of each mineral composition in the cement can be confirmed by a general analysis method. For example, a pulverized sample is subjected to a powder X-ray diffractometry to confirm the produced mineral composition and the data is analyzed by a Rietveld refinement, whereby the mineral composition can be quantified. In addition, the mineral composition amount can also be obtained by a calculation based on a chemical component and the identification result of the powder X-ray diffraction.

The cement may be configured such that Al₂O₃ is not contained in the γ-crystalline phase. As a result, the workability, compression strength, storage stability, and temperature dependence can be improved.

The cement may be further configured to contain a β-crystalline phase composed of β-2CaO·SiO₂.

A lower limit of a content of the β-C₂S is, for example, equal to or more than 1.0, by mass, preferably equal to or more than 2.0% by mass and more preferably equal to or more than 3.0% by mass with respect to 100% by mass of the γ-C₂S. As a result, the compression strength can be improved.

On the other hand, an upper limit of the content of the Di-C₂S is, for example, equal to or less than 50% by mass, preferably equal to or less than 30% by mass and more preferably equal to or less than 20% by mass with respect to 100% by mass of the γ-C₂S. As a result, a decrease in condensation curing can be suppressed.

The cement containing the β-C₂S may be configured such that Al₂O₃ is contained in the β-crystalline phase. As a result, the workability, compression strength, storage stability, and temperature dependence can be improved.

The cement may contain a glass phase and/or CaO·2Al₂O₃ (hereinafter, also abbreviated as CA₂).

A lower limit of a content of the glass phase is, for example, equal to or more than 20% by mass, preferably equal to or more than 30% by mass and more preferably equal to or more than 40% by mass with respect to 100% by mass of the γ-C₂S. As a result, it is possible to obtain a cement entirely powdered.

On the other hand, an upper limit of the content of the glass phase is, for example, equal to or less than 120% by mass, preferably equal to or less than 100% by mass and more preferably equal to or less than 90% by mass with respect to 100% by mass of the γ-C₂S. As a result, it is possible to obtain a cement entirely powdered.

A lower limit of a content of the CA₂ is, for example, equal to or more than 0.01% by mass, preferably equal to or more than 0.05% by mass and more preferably equal to or more than 0.1% by mass with respect to 100% by mass of the γ-C₂S. As a result, it is possible to obtain a cement entirely powdered.

On the other hand, an upper limit of the content of the CA₂ is, for example, equal to or less than 20% by mass, preferably equal to or less than 18% by mass and more preferably equal to or less than 15% by mass with respect to 100% by mass of the γ-C₂S. As a result, it is possible to obtain a cement entirely powdered.

A method for producing the cement will be described.

The method for producing the cement includes a step of, for example, baking a raw material mixture containing a CaO raw material, an SiO₂ raw material, and an Al₂O₃ raw material using a kiln.

As the CaO raw material, a commercially available material as an industrial raw material may be used, and for example, one or two or more selected from the group consisting of industrial wastes such as limestone, coal ash, quicklime, slaked lime, acetylene waste, steel slag (converter slag or electric furnace slag), wood biomass combustion ash, fine powder generated from waste concrete lumps, concrete sludge, and incineration ash of municipal waste, and purified calcium carbonate obtained from these industrial wastes may be contained. Among these, slaked lime or by-product slaked lime may be used.

As the SiO₂ raw material, a commercially available material as an industrial raw material may be used, and examples thereof include silicon stone, silica sand, quartz, and diatomaceous earth. These may be used alone or in combination of two or more kinds thereof. These may be not used as long as the CaO raw material or the Al₂O₃ raw material contains a required amount of SiO₂.

For example, in a case where coal ash containing SiO₂ is used as the CaO raw material, the above-described SiO₂ raw material may not be added.

Here, the coal ash (fly ash and the like) is a general term for, for example, coal combustion ash and the like, which are obtained by burning coal discharged from a boiler of a thermal power plant. The coal ash is, for example, ash generated from a coal-fired power plant, and coal ash generated by combustion of fine powder coal and collected by falling from a combustion gas of a combustion boiler as it passes through an air preheater, an economizer, or the like; coal ash collected by an electrostatic precipitator; coal ash falling to the bottom of the combustion boiler; or the like can be used.

As the Al₂O₃ raw material, a commercially available material as an industrial raw material may be used, but for example, one or two or more selected from the group consisting of bauxite, aluminum hydroxide, and aluminum residual ash may be used. The aluminum residual ash may be mainly composed of aluminum hydroxide. Among these, bauxite may be used.

These raw materials are mixed and pulverized after being formulated to have a predetermined mineral composition proportion after the baking, thereby obtaining a raw material mixture.

The method of the mixing and pulverization is not particularly limited, and a dry pulverization method or a wet pulverization method can be applied. In a case of the wet pulverization method, it is necessary to perform a dehydration treatment in order to granulate the raw material mixture. In addition, in a case where quicklime is used as the raw material, it is desirable to perform the treatment in a dry state.

In addition, a γ-C₂S/C₂AS ratio in the cement can be controlled by adjusting a charging proportion of the raw materials.

The raw material mixture may be granulated before the baking. The granules are adjusted to an appropriate size, for example, may be 0.5 to 20.0 cm.

The baking temperature may be, for example, 1,200° C. to 1,600° C., and is preferably 1,300° C. to 1,550° C. and more preferably 1,400° C. to 1,450° C.

A kiln such as a rotary kiln can be used for the baking.

For example, a rotary kiln in which bricks of a baking band are formed of high-purity alumina bricks having an Al₂O₃ content of equal to or more than 99% based on mass may be used, and/or an alumina mortar adjusted to an appropriate concentration may be applied to an inner surface of the bricks of the baking band in the rotary kiln before the baking.

The cement may be obtained as an inorganic baked product (clinker) by baking an inorganic raw material, or may be obtained as a powdery inorganic baked product by pulverizing the clinker.

The cement composition according to the present embodiment contains at least the above-described cement, and may contain water or sand as necessary. The cement composition is any one of a cement paste, a cement mortar, or a cement concrete.

In the present specification, the cement paste can be defined as containing cement and water, the cement mortar can be defined as containing cement, water, and sand (fine aggregate), and the cement concrete can be defined as containing cement, water, and aggregate (fine aggregate or coarse aggregate).

An amount of the cement used varies depending on the purpose of use, but is usually, for example, 1 to 90 parts by mass, preferably 2 to 80 parts by mass and more preferably 3 to 70 parts by mass in 100 parts by mass of the cement composition.

In the present specification, the term “to” indicates that the upper limit value and the lower limit value are included, unless particularly stated otherwise.

The above-described cement composition may be configured not to contain Portland cement such as normal Portland cement, early-strength Portland cement, ultrahigh-early-strength Portland cement, low-heat Portland cement, and moderate-heat Portland cement. That is, the cement according to the present embodiment can be used alone without being used in combination with the Portland cement.

An amount of the water used is not particularly limited, but a water/cement ratio in the cement composition is usually, for example, approximately 25% to 70% by mass, and may be 30% to 60% by mass.

In addition, in the cement composition, as necessary within a range that does not substantially hinder the object of the present invention, it is possible to use, in combination, one or two or more kinds of aggregate such as sand (fine aggregate) and gravel (coarse aggregate), an expansion material, a rapid hardening material, a coagulation adjuster, a water reducing agent, a high-performance water reducing agent, an AE agent, an AE water reducing agent, a high-performance AE water reducing agent, a thickener, an antirust agent, an antifreeze agent, a hydration heat suppressant, a polymer emulsion, a clay mineral such as bentonite and montmorillonite, an ion exchanger such as zeolite, hydrotalcite, and hydrocalumite, a sulfate such as aluminum sulfate and sodium sulfate, a phosphate, and a borate.

The kneading method is not particularly limited, and a generally used method can be used. As the mixing device, any stirring device can be used, and for example, a conical mixer, an omni mixer, a V-type mixer, a Henschel mixer, a Nauta mixer, or the like can be used.

The cement and water may be mixed with each other at the time of construction, and it is not a problem that a part or all of the materials are mixed with each other in advance.

The cement according to the present embodiment and the above-described cement composition containing the cement have an air hardenability in which the cement is cured by a carbonation reaction using a CO₂-containing gas or the like. By curing the cement composition, a cured cement product is obtained.

An example of a method for producing the cured cement product may be any method of curing the above-described cement composition in an environment condition including a CO₂-containing gas, and for example, the method includes a curing step of curing the above-described cement composition in an environment condition of a temperature of equal to or higher than 10° C. and equal to or lower than 150° C., a relative humidity of equal to or more than 10% and equal to or less than 80%, a CO₂ concentration of equal to or more than 0.1% and equal to or less than 90%, and a water vapor pressure of equal to or more than 3.0 hPa and equal to or less than 300 hPa, preferably in an environment condition of a temperature of equal to or higher than 15° C. and equal to or lower than 130° C., a relative humidity of equal to or more than 20% and equal to or less than 70%, a CO₂ concentration of equal to or more than 0.5, and equal to or less than 80%, and a water vapor pressure of equal to or more than 5.0 hPa and equal to or less than 250 hPa.

A curing time in the curing step can be appropriately changed depending on the application, but may be, for example, equal to or more than 1 hour and equal to or less than 90 hours, preferably equal to or more than 3 hours and equal to or less than 80 hours.

The curing method is not particularly limited, and any curing method such as curing at normal temperature and normal pressure, steam curing, steam curing at high-temperature and high-pressure, and pressurized curing, which is generally performed, can be applied.

In addition, in the curing step of the method for producing the cured cement product, a pressure-molded product is obtained by subjecting the above-described cement composition to a pressure-molding, or by subjecting a water slurry containing the above-described cement composition to a pressure-molding, and the pressure-molded product is cured in the above-described environment condition.

The embodiments of the present invention have been described above, but these are examples of the present invention and various configurations other than the above can be adopted. In addition, the present invention is not limited to the above-described embodiments, and modifications, improvements, and the like within the range in which the object of the present invention can be achieved are included in the present invention.

Hereinafter, examples of the reference aspect will be added.

A first example of the cement is an air hardening cement containing a γ-crystalline phase composed of γ-2CaO·SiO₂ (γ-C₂S), a β-crystalline phase composed of β-2CaO·SiO₂ (β-C₂S), and 2CaO·Al₂O₃·SiO₂ (C₂AS).

A second example of the cement is an air hardening cement containing a γ-crystalline phase composed of γ-2CaO·SiO₂ (γ-C₂S) and 2CaO·Al₂O₃·SiO₂ (C₂AS).

A third example of the cement is an air hardening cement containing a γ-crystalline phase composed of γ-2CaO·SiO₂ (γ-C₂S) and a β-crystalline phase composed of β-2CaO·SiO₂ (β-C₂S).

### EXAMPLES

Hereinafter, the present invention will be described in detail with reference to Examples, but the present invention is not limited to the description of Examples.

### <Production of Cement>

### (Raw Material Used)

By-product slaked lime: slaked lime which was a by-product after generating acetylene by reacting calcium carbide with water; SiO₂ was 0.8% by mass, Al₂O₃ was 0.6% by mass, Fe₂O₃ was 0.3% by mass, CaO was 68.5% by mass, MgO was 0.02% by mass, Na₂O was 0.01% by mass, K₂O was 0.01% by mass, and SO₃ was 0.5% by mass; a loss on ignition (L.O.I.) was 24.1% by mass.
Silicastone: silicastone fine powder; SiO₂ was 99.3% by mass, Al₂O₃ was 0.01% by mass, Fe₂O₃ was 0.0% by mass, CaO was 0.0% by mass, MgO was 0.04% by mass, Na₂O was 0.02% by mass, K₂O was 0.3% by mass, and SO₃ was 0.04% by mass; a loss on ignition (L.O.I.) was 0.6% by mass.
Alumina: Al₂O₃ was 99.03% by mass, SiO₂ was 0.14% by mass, Fe₂O₃ was less than 0.01% by mass, CaO was less than 0.01% by mass, and TiO₂ was 0.06% by mass; a loss on ignition (L.O.I.) was 0.82% by mass.

### (Cement A)

As a raw material containing CaO and SiO₂, the by-product slaked lime and the silicastone described above were blended to have a CaO/SiO₂ molar ratio shown in Table 1, and the mixture was dry-mixed and pulverized to obtain a mixed raw material. The obtained mixed raw material was granulated to produce granules having a diameter of approximately 1 cm to 2.5 cm.

The obtained granules were put into a rotary kiln including bricks of a baking band made of high-purity alumina brick (Al₂O₃ content was equal to or more than 99% based on mass), and baked at a baking temperature of 1,400° C. to synthesize a clinker pulverized in a process of cooling to room temperature. The obtained clinker powder product was used as a cement A.

### (Cement B and Cement C)

Clinker powder products having the mineral proportions shown in Table 1 were synthesized in the same manner as in the cement A, and were used as a cement B and a cement C, except that the above-described alumina was used instead of the silicastone, and the CaO/SiO₂ molar ratio and the Al₂O₃ content shown in Table 1 were adopted.

### (Cement D)

A calcium carbonate-based powder having a purity of equal to or more than 99.0% by mass and a silicon oxide-based powder having a purity of equal to or more than 99.0% by mass were mixed with each other such that a molar ratio of CaO/SiO₂ was 2.0, and the mixture was heat-treated at 1,400° C. for 2 hours and slowly cooled in an electric furnace to synthesize a γ-C₂S powder. The obtained γ-C₂S powder was used as a cement D.

In the γ-C₂S powder obtained here, C₂AS and C₁₂A₇ were not contained as solid solutions.

As a result of performing an elemental surface analysis using the obtained SEM image and an energy-dispersive X-ray spectrometer (EDS), it was found that, in the cement A to the cement C, C₂AS was present in the γ-crystalline phase formed by γ-C₂S, and Al₂O₃ was not contained in the γ-crystalline phase. In addition, in the cement A to the cement C, β-C₂S was confirmed, and it was found that Al₂O₃ was contained in the β-crystalline phase formed by the β-C₂S.

In addition, as a result of observing a fracture surface of the obtained clinker powder of the cement A to the cement C using SEM, it was found that C₂AS was present in the γ-crystalline phase formed by γ-C₂S.

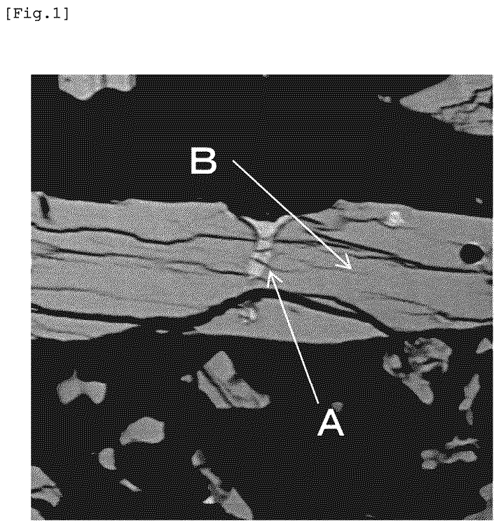

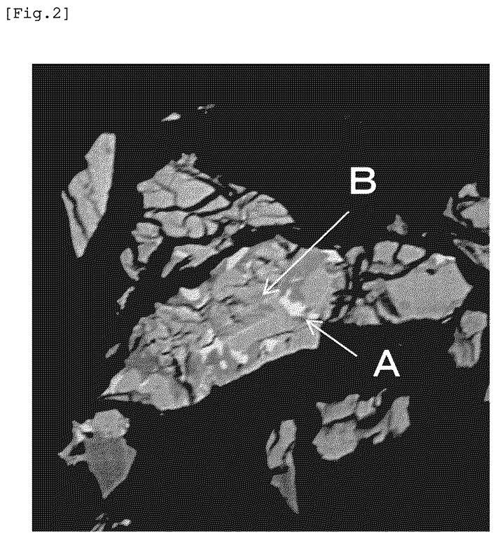

FIG. 1 shows an SEM image of the fracture surface of the clinker of the cement A, and FIG. 2 shows an SEM image of the fracture surface of the clinker of the cement B. In FIGS. 1 and 2, an arrow A (white region) indicates the C₂AS, and an arrow B (gray region) indicates the γ-C₂S.

TABLE 1

| | Cement | | | | | | | |
|---|---|---|---|---|---|---|---|---|
| | | | | | In mixed raw | | Blaine | |
| | Mineral composition | | | | material | | specific | |
| | (% by mass) | | | | Cao/SiO₂ | Al₂O₃ content | surface | Workability |
| | ν-C₂S | C₂AS | β-C₂S | Total | molar ratio | (% by mass) | area (cm²/g) | (mm) |
| Cement A | 92.0 | 2.5 | 5.5 | 100.0 | 1.9 | 1 | 3,500 | Good |
| Cement B | 54.2 | 21.1 | 24.7 | 100.0 | 2.1 | 10 | 3,500 | Good |
| Cement C | 76.2 | 7.7 | 16.1 | 100.0 | 2.2 | 10 | 3,500 | Good |
| Cement D | 100.0 | 0 | 0 | 100.0 | 2.0 | 0 | 3,500 | Good |

| | | | | Temperature | | |
|---|---|---|---|---|---|---|
| | | Storage stability | | dependence | | |
| | Compression | | Compression | | Compression | |
| | strength | Flow | strength | Flow | strength | |
| | (N/mm²) | ratio | ratio | ratio | ratio | Note |
| Cement A | Good | Good | Good | Good | Good | Example 1 |
| Cement B | Good | Good | Good | Good | Good | Example 2 |
| Cement C | Good | Good | Good | Good | Good | Example 3 |
| Cement D | Good | Good | Bad | Good | Bad | Comparative |
| | | | | | | Example 1 |

In Table 1, γ-C₂S represents γ-2CaO·SiO₂, β-C₂S represents β-2CaO·SiO₂, and C₂AS represents 2CaO·Al₂O₃·SiO₂.

In Table 1, the proportion of the mineral composition was calculated based on the result of the quantitative analysis of the chemical composition using fluorescent X-ray and the identification result by the powder X-ray diffraction.

The obtained cement was evaluated based on the following evaluation items.

### <Workability, Compression Strength, Storage Stability, and Temperature Dependence>

### (Preparation of Mortar)

The cement (any of the cements A to D of Examples 1 to 3 and Comparative Example), water (tap water), and sand (JIS standard sand) were mixed with each other in a room at 20° C. to prepare a mortar having a water/cement blending ratio=1/1 (mass ratio) and a cement/sand blending ratio=1/3 (mass ratio).

Using the mortar (sample A) immediately after the preparation, workability, compression strength (strength), storage stability, and temperature dependence were measured as follows.

### (Test Method)

Workability: using the sample A immediately after the preparation (stored for 0 months), a flow value at 20° C. was measured according to a flow test of JIS R 5201.
Compression strength (strength): using the sample A immediately after the preparation (stored for 0 months), in an environment of a temperature of 20° C., a relative humidity of 60% RH, a CO₂ concentration of 55, and a water vapor pressure of 9.2 hPa, a compressive strength at a material age of 28 days was measured according to JIS R 5201.
Storage stability: each of the cements A to D immediately after the production was put in a vinyl bag and sealed, and stored for 3 months under conditions of a temperature of 20° C. and a humidity of 60%; a mortar (sample B) was prepared in the same manner as in (Preparation of mortar) described above, except that the cements A to D stored for 3 months were used;
using the sample B immediately after the preparation (stored for 3 months), the workability (flow value) and the compression strength were measured under the same conditions as in the sample A described above;
next, a relative ratio of each test result of the sample B stored for 3 months to each test result of the sample A stored for 0 months was obtained.
Temperature dependence: the workability and the compression strength were measured using the sample A immediately after the preparation (stored for 0 months) under the same conditions as described above, except that the test temperature was changed to 5° C., and a relative ratio of each test result at 5° C. to each test result at 20° C. was obtained.

In Table 1, in each of the tests of workability, compression strength, storage stability, and temperature dependence, a case where the sample could be used without any problem in practical use is indicated as “Good”, and a case where a problem in practical use may occur is indicated as “Bad”.

In addition, the above-described cements of Examples 1 to 3 were mixed with sand (JIS standard sand) and 5% of water in a room at 20° C., and the obtained mixture was pressure-molded at 30 MPa to prepare a mortar pellet (pressure-molded product) having a size of 4 cm×4 cm×16 cm. The obtained pressure-molded product was cured in an environment of a temperature of 20° C., a relative humidity of 60% RH, a CO₂ concentration of 5%, and a water vapor pressure of 9.2 hPa, thereby obtaining a cured cement product having practical compression strength.

The cements of Examples 1 to 3 were excellent in workability and compression strength, and the cements of Examples 1 to 3 had higher storage stability and lower temperature dependence than those of Comparative Example 1. The cement of each of Examples can be suitably used as a cement which is cured by a carbonation reaction.

Priority is claimed on Japanese Patent Application No. 2022-019299, filed Feb. 10, 2022, the disclosure of which is incorporated herein by reference.

1. A cement which is cured by a carbonation reaction, the cement comprising:
a γ-crystalline phase composed of γ-2CaO·SiO₂ (γ-C₂S);
a β-crystalline phase composed of β-2CaO·SiO₂ (β-C₂S); and
2CaO·Al₂O₃·SiO₂ (C₂AS).

2. The cement according to claim 1,
wherein a content of the γ-C₂S is equal to or more than 30% by mass and equal to or less than 98% by mass in 100% by mass of the cement.

3. The cement according to claim 1,
wherein a content of the C₂AS is equal to or more than 0.5% by mass and equal to or less than 50% by mass with respect to 100% by mass of the γ-C₂S.

4. The cement according to claim 1,
wherein the cement contains a heterophase existing in the γ-crystalline phase, and the C₂AS is contained in the heterophase.

5. The cement according to claim 4,
wherein Al₂O₃ is not contained in the γ-crystalline phase.

6. The cement according to claim 1,
wherein Al₂O₃ is contained in the β-crystalline phase.

7. The cement according to claim 1,
wherein a content of the β-C₂S is equal to or more than 1.0% by mass and equal to or less than 50% by mass with respect to 100% by mass of the γ-C₂S.

8. The cement according to claim 1,
wherein the cement is in a powder form.

9. A cement composition comprising:
the cement according to claim 1,
wherein the cement composition is any one of a cement paste, a cement mortar, or a cement concrete.

10. The cement composition according to claim 9,
wherein the cement composition does not contain a Portland cement.

11. A cured cement product which is a cured product of the cement composition according to claim 9.

12. A method for producing a cured cement product, comprising:
a curing step of curing the cement composition according to claim 9 in an environment condition of a temperature of equal to or higher than 10° C. and equal to or lower than 150° C., a relative humidity of equal to or more than 10% and equal to or less than 80%, a CO₂ concentration of equal to or more than 0.1% and equal to or less than 90%, and a water vapor pressure of equal to or more than 3.0 hPa and equal to or less than 300 hPa.

13. The method for producing a cured cement product according to claim 12,
wherein a curing time in the curing step is equal to or more than 1 hour and equal to or less than 90 hours.

14. A method for producing a cured cement product, comprising:
a curing step of curing the cement composition according to claim 9 in an environment condition of a temperature of equal to or higher than 10° C. and equal to or lower than 150° C., a relative humidity of equal to or more than 10% and equal to or less than 80%, a CO₂ concentration of equal to or more than 0.1% and equal to or less than 90%, and a water vapor pressure of equal to or more than 3.0 hPa and equal to or less than 300 hPa,
wherein, in the curing step, a pressure-molded product is obtained by subjecting the cement composition to a pressure-molding, or by subjecting a water slurry containing the cement composition to a pressure-molding, and the pressure-molded product is cured in the environment condition.
